(19) United States
(12) Patent Application Publication
(10) Pub. No.: US 2009/0181174 A1
(43) Pub. Date: Jul. 16, 2009

(54) METHOD OF TREATING SUBSTRATE AND COMPUTER STORAGE MEDIUM

(75) Inventors: Kousuke YOSHIHARA, Koshi-shi (JP); Tomohiro Iseki, Koshi-shi (JP); Koji Takayanagi, Koshi-shi (JP); Kentaro Yoshihara, Koshi-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 12/348,513

(22) Filed: Jan. 5, 2009

(30) Foreign Application Priority Data
Jan. 16, 2008 (JP) 2008-006519

(51) Int. Cl. B05D 3/02

(52) U.S. Cl. 427/314

(57) ABSTRACT

In the present invention, a substrate is adjusted in temperature such that its contact portion held on a substrate holding unit and its outer peripheral portion outside the contact portion are at different temperatures. The temperature of the contact portion is adjusted such that the contact portion and the substrate holding unit are at the same temperature when the substrate is held on the substrate holding unit. The temperature-adjusted substrate is then held and rotated by the substrate holding unit, and a coating solution is applied onto the rotating substrate to form a coating film with a uniform film thickness, so that even if the number of times of coating treatment for substrates increases, the film thickness of the coating film to be formed on the substrate can be made uniform.

### BACKGROUND OF THE INVENTION

1. Field of the Invention

The present invention relates to a method of treating a substrate, for example, a semiconductor wafer or the like and a computer storage medium.

2. Description of the Related Art

In photolithography processing in manufacturing a semiconductor device, for example, after the temperature of, for example, a semiconductor wafer (hereinafter, referred to as a “wafer”) is adjusted, resist coating treatment of applying a resist solution onto the wafer to form a resist film, is performed.

In the above-described resist coating treatment, the resist solution is typically supplied with the wafer being held on a spin chuck and rotated. The resist solution supplied to the center of the wafer is diffused over the entire front surface of the wafer by the centrifugal force, whereby a resist film is formed on the front surface of the wafer.

When the resist solution is supplied to the rotating wafer, however, a difference occurs in evaporation rate of a solvent in the resist solution due to the difference in circumferential speed between the central portion and the peripheral portion of the wafer, resulting in a difference in film thickness of the resist film between the central portion and the peripheral portion. Hence, to make the film thickness of the resist film uniform within the wafer, a method has been proposed to maintain a temperature distribution within the wafer by the temperature adjustment for the wafer before the resist coating treatment. For example, if the film thickness at the peripheral portion of the wafer is larger than the film thickness at the central portion, the temperature distribution within the wafer is controlled such that the temperature at the central portion is higher than the temperature at the peripheral portion according to the degree of the difference therebetween (Japanese Patent Application Laid-open No. H5-36597).

### SUMMARY OF THE INVENTION

In the case where the temperature of the wafer is adjusted such that the temperatures at the central portion and the peripheral portion are different according to the difference in circumferential speed as described above, the film thickness of the resist film can be made uniform for a wafer which is subjected to coating treatment immediately after the adjustment. However, since the temperature adjustment is performed such that the temperatures within the wafer are different between the central portion and the peripheral portion without consideration of the temperature difference between the spin chuck and the wafer, the coating film could be nonuniform if a temperature difference occurs between the spin chuck and the wafer. More specifically, when the temperature of the central portion of the temperature-adjusted wafer that is a portion of the wafer to be held on the spin chuck is higher than the temperature of the spin chuck, the heat transferred from the wafer to the spin chuck is gradually stored in the spin chuck as the number of times of coating treatment for wafers increases, resulting in an increase in temperature of the spin chuck.

Then, the temperature at the central portion of the wafer rises under the influence of the increase in temperature of the spin chuck to cause the film thickness at the central portion of the wafer to be larger than the film thickness at the peripheral portion. Conversely, for example, when the temperature at the central portion of the temperature-adjusted wafer is lower than the temperature of the spin chuck, the temperature of the spin chuck lowers to cause the film thickness at the central portion of the wafer to be smaller than the film thickness at the peripheral portion. As described above, the film thickness of the resist film to be formed on the wafer has become more nonuniform with an increase in the cumulated number of times of coating treatment for wafers.

The present invention has been developed in consideration of the above point, and it is an object to make the film thickness of a coating film to be formed on a substrate uniform even when the number of times of coating treatment for substrates increases.

To attain the above object, the present invention is a method of treating a substrate including: a temperature adjustment step of adjusting a temperature of the substrate; and a coating treatment step of thereafter holding the substrate by a holding member and applying a coating solution onto the substrate, wherein in the temperature adjustment step, a temperature of a contact portion of the substrate coming into contact with the holding member is adjusted to be the same as a temperature of the holding member when the substrate is held on the holding member.

According to the present invention, since in the temperature adjustment step, the temperature of the contact portion of the substrate coming into contact with the holding member is adjusted to be the same as the temperature of the holding member when the substrate is held on the holding member, there is no heat transfer between the substrate and the holding member, so that the temperature of the holding member never changes even in the case where the coating treatment is performed for substrates in succession. Accordingly, even if a large number of times of treatment for substrates are performed, the holding member does not store heat therein, and nonuniformity in film thickness of the coating film due to a variation in temperature of the holding member never occurs as a matter of course.

The temperature of the holding member may be measured, and the temperature adjustment of the contact portion in the temperature adjustment step may be controlled based on the measured temperature of the holding member. Thereby even if the temperature of the holding member changes, for example, due to the an external factor, the temperature of the contact portion can be adjusted according to the change so as to make the film thickness of the coating film to be formed on the substrate uniform more stably. Note that the control of the temperature adjustment of the contact portion may be performed for each substrate or for every predetermined number of substrates.

In the temperature adjustment step, a temperature of a portion of the substrate other than the contact portion may be adjusted to be different from the temperature of the contact portion. For example, if the film thickness of the coating film formed on the substrate after the coating treatment is larger at the outer side than at the inner side, the temperature adjustment is performed such that the temperature of the portion other than the contact portion is higher than the temperature of the contact portion. Conversely, if the coating film at the outer side is thinner than the coating film at the inner side, the temperature adjustment is performed such that the temperature at the portion other than the contact portion is lower than the temperature of the contact portion.

The present invention according to another aspect is a computer-readable storage medium storing a program running on a computer of a control unit which controls a substrate treatment apparatus in order to execute the above-described method of treating a substrate by the substrate treatment apparatus.

According to the present invention, the film thickness of a coating film on the substrate can be made uniform even when substrates are subjected to treatment in succession and therefore the number of times of treatment increases.

### BRIEF DESCRIPTION OF THE DRAWINGS

FIG. 1 is a plan view showing the outline of a configuration of a coating treatment system for implementing a method of treating a wafer according to the present embodiment;

FIG. 2 is a longitudinally sectional view showing the outline of a configuration of a resist coating apparatus;

FIG. 3 is a plan view showing the outline of the configuration of the resist coating apparatus;

FIG. 4 is a longitudinally sectional view showing the outline of a configuration of a temperature adjusting apparatus;

FIG. 5 is a plan view showing the outline of the configuration of the temperature adjusting apparatus;

FIG. 6 is an explanatory view showing an appearance of a wafer after temperature adjustment;

FIG. 7A shows an appearance of a resist film on the wafer which is thicker at the outer side than at the inner side, FIG. 7B shows an appearance of a resist film on the wafer which is thinner at the outer side than at the inner side, and FIG. 7C shows an appearance of a resist film on the wafer which has been uniformly formed;

FIG. 8 is a longitudinally sectional view showing the outline of a configuration of a resist coating apparatus according to another embodiment; and

FIG. 9 is a longitudinally sectional view showing the outline of a configuration of a resist coating apparatus according to another embodiment.

### DETAILED DESCRIPTION OF THE INVENTION

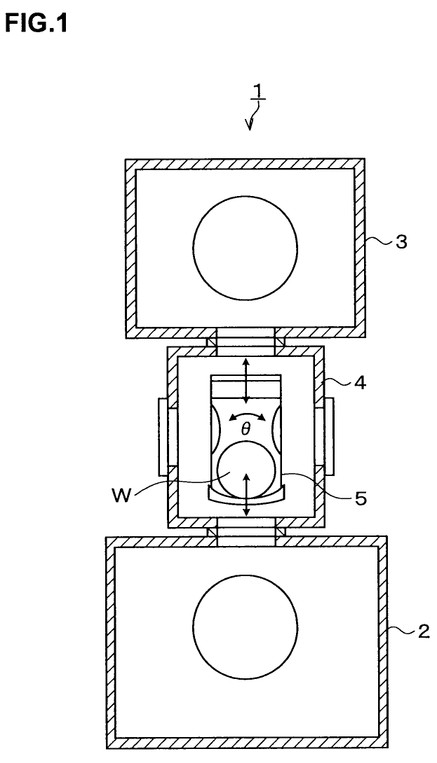

Hereinafter, preferred embodiments of the present invention will be described. FIG. 1 is a plan view showing the outline of a configuration of a coating treatment system 1 for implementing a method of treating a wafer W according to the present embodiment.

The coating treatment system 1 has a resist coating apparatus 2 which applies a resist solution as a coating solution, for example, onto the front surface of the wafer W to form a resist film, and a temperature adjusting apparatus 3 which adjusts the temperature of the wafer W before the coating treatment, as shown in FIG. 1. Between the resist coating apparatus 2 and the temperature adjusting apparatus 3, a transfer apparatus 4 is provided for transferring the wafer W from/to the outside to/from the coating treatment system 1, and transferring the wafer W to/from the resist coating apparatus 2 and the temperature adjusting apparatus 3. Inside the transfer apparatus 4, a transfer arm 5 is provided which supports and transfers the wafer W. Note that the temperature of the atmosphere in the transfer apparatus 4 is kept at, for example, 28° C.

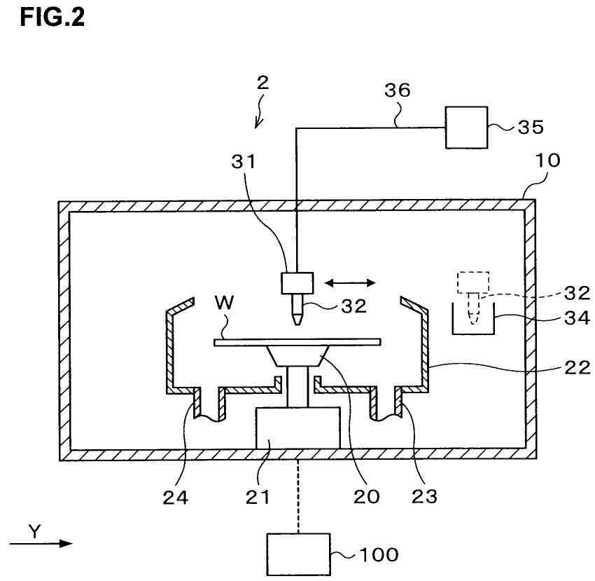

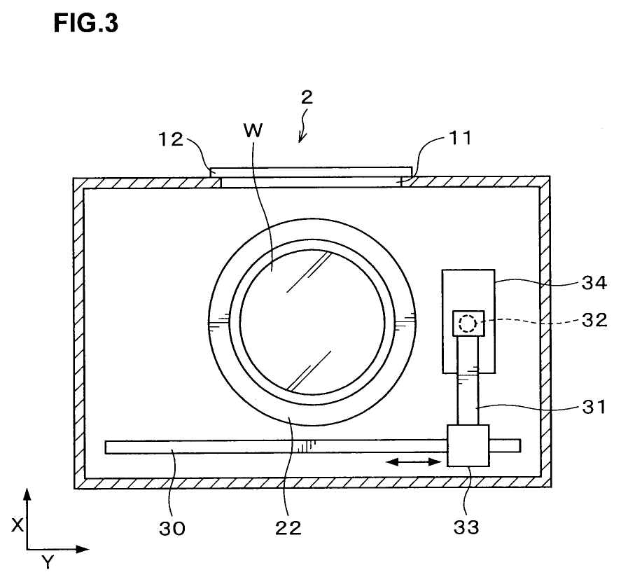

The resist coating apparatus 2 has a treatment container 10 capable of closing its inside as shown in FIG. 2. In a side surface of the treatment container 10 on the transfer apparatus side 4, a transfer-in/out port 11 for the wafer W is formed in the surface facing a transfer-in region for the transfer arm 5 as shown in FIG. 3, and an opening/closing shutter 12 is provided at the transfer-in/out port 11.

At the central portion in the treatment container 10, a spin chuck 20 is provided as a holding member which holds and rotates the wafer W thereon as shown in FIG. 2. The spin chuck 20 has a horizontal upper surface, and the upper surface is provided with a suction port (not shown) which sucks, for example, the wafer W. Suction through the suction port allows the wafer W to be sucked and held on the spin chuck 20.

The spin chuck 20 has a chuck drive mechanism 21 which includes, for example, a motor and so on, and can rotate at a predetermined speed by means of the chuck drive mechanism 21. Further, the chuck drive mechanism 21 is provided with a raising and lowering mechanism such as a cylinder or the like so that the spin chuck 20 is vertically movable.

Around the spin chuck 20, a cup 22 is provided which receives and collects liquid splashing or dropping from the wafer W. A drain pipe 23 for draining the collected liquid and an exhaust pipe 24 for exhausting the atmosphere in the cup 22 are connected to the bottom surface of the cup 22. Note that the temperature of the atmosphere in the cup 22 is kept at a temperature higher than that of the outside of the treatment container 10, for example, at 28° C.

As shown in FIG. 3, on the side of the negative direction in an X-direction (the lower direction in FIG. 3) in the cup 22, a rail 30 is formed which extends along a Y-direction (the right-to-left direction in FIG. 3). The rail 30 is formed, for example, from the outside on the negative direction side in the Y-direction of the cup body 22 (the left direction in FIG. 3) to the outside on the positive direction side in the Y-direction of the cup body 22 (the right side in FIG. 3). To the rail 30, an arm 31 is attached.

On the arm 31, a nozzle 32 which discharges the resist solution is supported as shown in FIG. 2 and FIG. 3. The arm 31 is freely movable on the rail 30 by means of a nozzle drive unit 33 shown in FIG. 3. This allows the nozzle 32 to move from the a waiting section 34 set on the outside on the positive direction side in the Y-direction of the cup 22 to above the central portion of the wafer W in the cup 22, and further move in the radial direction of the wafer W above the front surface of the wafer W. The arm 31 freely raises and lowers by means of the nozzle drive unit 33 to be able to adjust the height of the nozzle 32. To the nozzle 32, a supply pipe 36 in communication with a resist solution supply source 35 is connected as shown in FIG. 2. Note that the temperature of the resist solution discharged from the nozzle 32 is, for example, 33° C.

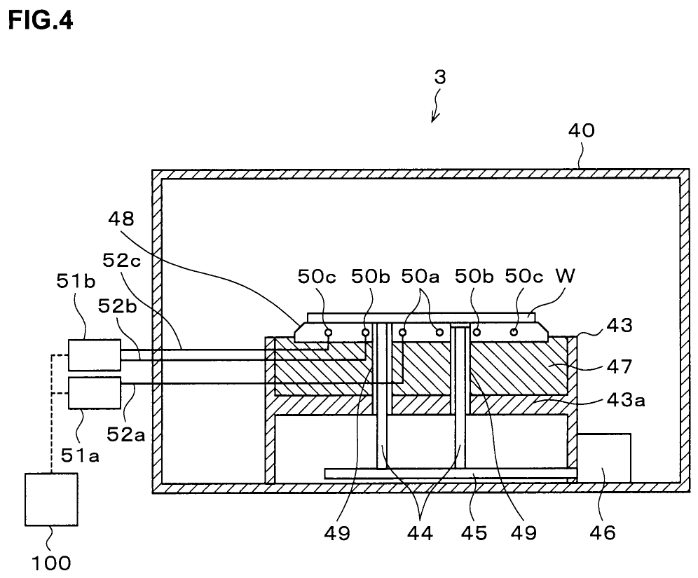

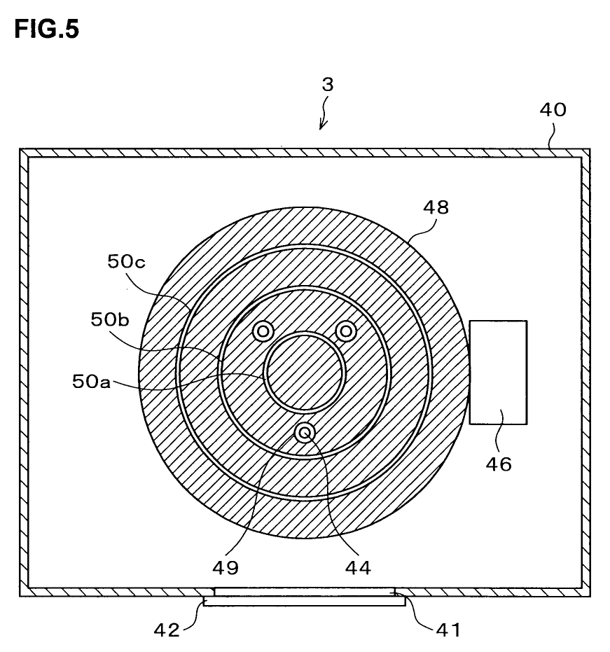

The temperature adjusting apparatus 3 has a treatment container 40 capable of closing its inside as shown in FIG. 4. In a side surface of the treatment container 40 on the transfer apparatus side 4, a transfer-in/out port 41 is formed in the surface facing a transfer-in region for the transfer arm 5 as shown in FIG. 5, and an opening/closing shutter 42 is provided at the transfer-in/out port 41.

Inside the treatment container 40, a mounting table 43 is provided for horizontally mounting the wafer W thereon as shown in FIG. 4. Inside the mounting table 43, raising and lowering pins 44 for delivering the wafer W are installed supported by a supporting member 45. Three raising and lowering pins 44 are provided extending upward in the vertical direction through the mounting table 43 at regular intervals and concentrically about, for example, the center of the mounting table 43. At a base end portion of the supporting member 45, a drive mechanism 46 is provided which includes, for example, a motor for raising and lowering the raising and lowering pins 44 and the supporting member 45.

Inside the mounting table 43 and above the supporting member 45, a supporting surface 43a is provided. In a space in the mounting table 43 upper than the supporting surface 43a, a heat insulating material 47 is filled. On the upper surface of the heat insulating material 47, a cooling plate 48 is provided which adjusts the wafer W to a desired temperature. The supporting surface 43a, the heat insulating material 47, and the cooling plate 48 are formed with through holes 49 for the above-described raising and lowering pins 44 to be raised and lowered therethrough.

Inside the cooling plate 48, for example, three cooling pipes 50a, 50b, and 50c are provided concentrically about the center of the cooling plate 48 as shown in FIG. 5. To the innermost cooling pipe 50a, a supply pipe 52a is connected which communicates with a cooling medium supply source 51a as shown in FIG. 4, and to the two cooling pipes 50b and 50c located outside the cooling pipe 50a, supply pipes 52b and 52c are connected respectively which communicate with a cooling medium supply source 51b. The cooling medium supply sources 51a and 51b can individually control the cooling media to different temperatures by means of a control unit 100.

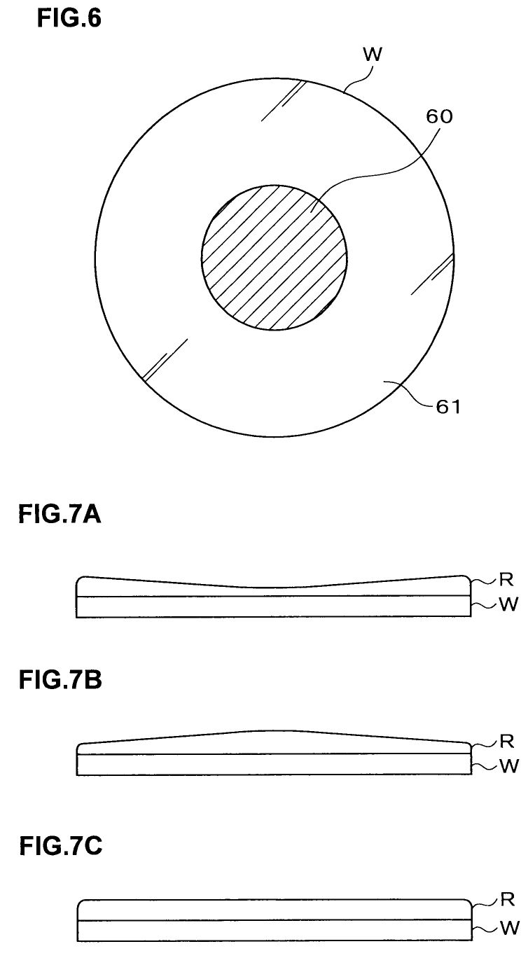

The inner cooling pipe 50a can cool a contact portion 60 (a hatched portion in the drawing) which comes into contact with the spin chuck 20 when the wafer W is held on the spin chuck 20 of the resist coating apparatus 2 as shown in FIG. 6. The outer cooling pipes 50b and 50c can cool an outer peripheral portion 61 of the wafer W other than the contact portion 60.

A cooling medium at, for example, 33° C. is circulated through the cooling pipe 50a to cool the contact portion 60. The temperature of the cooling medium is determined by the control unit 100 so that the temperature of the contact portion 60 and the temperature of the spin chuck 20 are the same temperature, that is, 28° C. when the wafer W is held on the spin chuck 20. Further, a cooling medium at, for example, 35° C. is circulated through the cooling pipes 50b and 50c to cool the outer peripheral portion 61. The temperature of the cooling medium is determined by the control unit 100 based on the discharge amount and the discharge rate of the resist solution from the nozzle 32, the number of rotations of the wafer W on the spin chuck 20 and so on so that the film thickness of a resist film to be formed on the wafer W becomes uniform. As for the decision of the temperature of the outer peripheral portion 61, for example, if a resist film R on the wafer W is thicker at the outer side than at the inner side as shown in FIG. 7A, the temperature of the outer peripheral portion 61 is decided to be higher than the temperature of the contact portion 60. Conversely, for example, if a resist film R on the wafer W is thinner at the outer side than at the inner side as shown in FIG. 7B, the temperature of the outer peripheral portion 61 is decided to be lower than the temperature of the contact portion 60. With such temperature adjustment of the wafer W, the resist film R with a uniform film thickness is formed on the wafer W as shown in FIG. 7C.

The control unit 100 is, for example, a computer, which has a program storage unit (not shown). In the program storage unit, a program is stored to control the temperatures of the cooling media to be supplied from the above-described cooling medium supply sources 51a and 51b to the cooling pipes 50a, 50b and 50c. In addition, a program is also stored to control the operations of the drive system of the resist coating apparatus 2, the temperature adjusting apparatus 3 and the transfer apparatus 4. Note that the programs in use are those stored in a storage medium such as a computer-readable hard disk (HD), flexible disk (FD), compact disk (CD), magneto-optical disk (MO), memory card or the like, and installed from the storage medium into the control unit 100.

Next, a treatment process of the wafer W performed in the coating treatment system 1 configured as described above will be described.

A preheated wafer W is first transferred to the temperature adjusting apparatus 3 by the transfer arm 5. The wafer W is delivered to the raising and lowering pins 44 and then mounted on the cooling plate 48. The cooling medium at 33° C. is circulated through the cooling pipe 50a in the cooling plate 48, and the cooling medium at 35° C. is circulated through the cooling pipes 50b and 50c. Thus, the contact portion 60 of the wafer W on the cooling plate is cooled to 33° C. and the outer peripheral portion 61 is cooled to 35° C. The wafer W thus temperature-adjusted is delivered to the transfer arm 5 by the raising and lowering pins 44.

The wafer W supported by the transfer arm 5 is transferred to the resist coating apparatus 2. The wafer W is delivered from the transfer arm 5 to the spin chuck 20 and suction-held on the spin chuck 20. In this event, the temperature of the atmosphere in the cup 22 is 28° C., and the temperature of the spin chuck 20 is also 28° C. Further, the temperature of the contact portion 60 of the wafer W is lowered by cooling during the transfer by the transfer arm 5 to be 28° C. that is the same as the temperature of the spin chuck 20.

The wafer W is then rotated at about 50 rpm by the spin chuck 20. Subsequently, a solvent is supplied onto the central portion of the rotating wafer W so that the wafer W is pre-wetted.

After completion of the pre-wetting of the wafer W, the nozzle 32 at the waiting section 34 is moved to above the central portion of the wafer W by the arm 31. Then, discharge of the resist solution is started from the nozzle 32 to the wafer W rotated at 50 rpm. The number of rotations of the wafer W is then increased to a high speed of about 3500 rpm, and the resist solution is continuously discharged from the nozzle 32 to the rotating wafer W. The resist solution is then scattered over the entire surface of the wafer W by the centrifugal force so that the resist solution is applied over the front surface of the wafer W.

Then, after a lapse of a predetermined time, the speed of the wafer W is decreased such that the number of rotations is decreased, for example, to 1000 rpm or lower, more preferably, to about 100 rpm, to flatten the resist solution on the wafer W for planarization.

Concurrently with the decrease of the speed of the wafer W, the nozzle 32 is moved by the arm 31 while continuously discharging the resist solution a predetermined distance, for example, 5 mm or more, more preferably, about 5 mm to about 30 mm in a radial direction of the wafer W from above the central portion of the wafer W. This displaces the discharge position of the resist solution on the front surface of the wafer W from the central portion of the wafer W. Note that the rotation speed of the wafer W in this event is maintained at a low speed of 100 rpm. The nozzle 32 is stopped at a position displaced from the position above the central portion of the wafer W by the predetermined distance, and at this moment the discharge of the resist solution is stopped. Then, the wafer W is continuously rotated at a low speed of 100 rpm to flatten the resist solution on the wafer W for planarization.

Then, after a lapse of a predetermined time, the rotation speed of the wafer W is increased to a middle speed, for example, at about 1500 rpm to dry the resist solution on the wafer W. Thus, a resist film is formed on the wafer W.

After completion of drying of the wafer W, the rotation of the wafer W is stopped, and the wafer W is transferred out from the top of the spin chuck 20, thus ending a series of wafer treatment.

According to the above embodiment, since the temperature of the contact portion 60 of the wafer W is adjusted in the temperature adjusting apparatus 3 so that the temperature of the contact portion 60 and the temperature of the spin chuck 20 are the same temperature when the wafer W is held on the spin chuck 20, no heat transfer occurs between the wafer W and the spin chuck 20, thereby preventing the spin chuck 20 from storing heat therein even after a large number of times of treatment for wafers W, resulting in no change in temperature of the spin chuck 20. Accordingly, once the temperature of the outer peripheral portion 61 of the wafer W is adjusted so that the film thickness of the resist film formed on the wafer W is uniform, the film thickness of the resist film can be made stably uniform even if the number of times of treatment for wafers W increases afterwards.

Further, the method of treating the wafer W in the present embodiment is especially effective to the case where the temperature of the atmosphere in the cup 22 when the resist solution is applied to the wafer W. The temperature of the atmosphere in the cup 22 in the present embodiment is 28° C. which is higher than 23° C. that is the temperature of the atmosphere in the cup 22 in the prior art (the temperature of the atmosphere outside the resist coating apparatus 2). Therefore, the time for drying the resist film can be reduced. According to the findings of the inventors, the drying time can be reduced by about 20% from that in the prior art. This can improve the throughput of the treatment of wafers W.

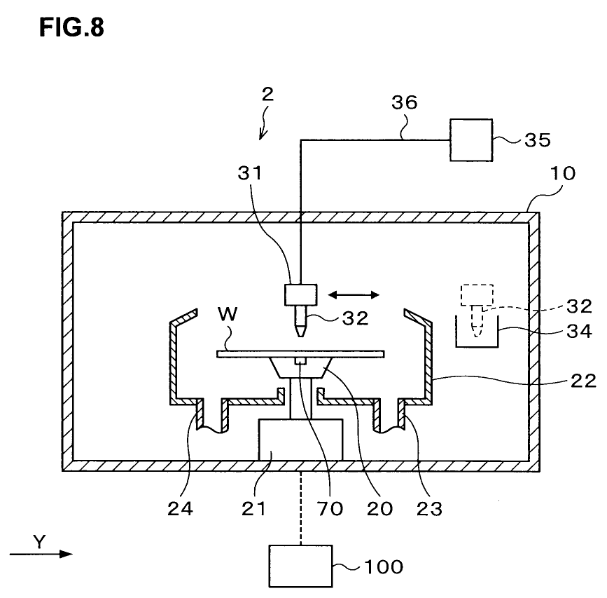

In the spin chuck 20 in the above embodiment, a sensor 70 may be provided which measures the surface temperature of the spin chuck 20 as shown in FIG. 8. The surface temperature of the spin chuck 20 measured by the sensor 70 is outputted to the control unit 100. In the control unit 100, the temperature of the cooling medium supplied from the cooling medium supply source 51a to the cooling pipe 50a is then decided based on the measured surface temperature of the spin chuck 20. The temperature of the spin chuck 20 is monitored to feedback-control the temperature of the cooling medium in the cooling pipe 50a as described above, whereby even if the temperature of the spin chuck 20 changes due to external factors such as generation of heat by the chuck drive mechanism 21 or the like, the temperature of the contact portion 60 when the wafer W is held on the spin chuck 20 and the temperature of the spin chuck 20 can be brought to the same temperature at all times. Accordingly, the film thickness of the resist film to be formed on the wafer W can be made uniform more stably. Note that the feedback control of the temperature adjustment of the contact portion 60 may be performed for each wafer W or for every predetermined number of wafers W.

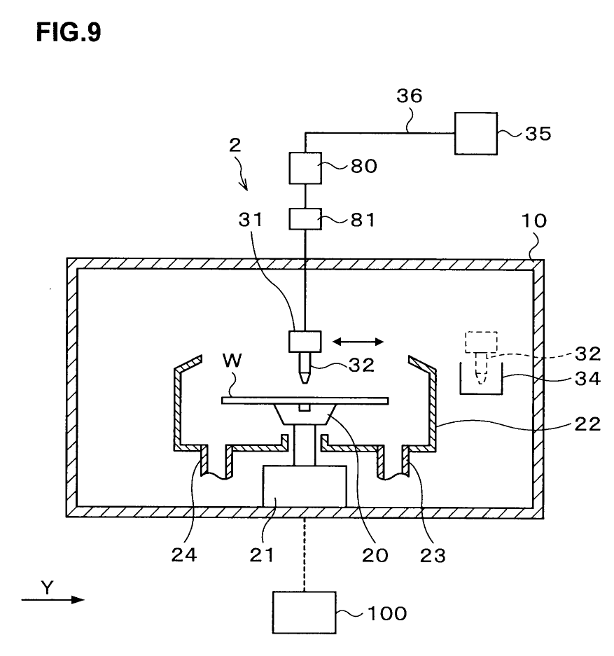

Along the supply pipe 36 connected to the nozzle 32 for the resist solution in the above embodiment, a heat processing apparatus 80 which heats the resist solution may be provided as shown in FIG. 9. In this case, the resist solution supplied from the resist solution supply source 35 is once heated by the heat processing apparatus 80 to a predetermined temperature, for example, 40° C., and kept for a certain period. Then, the resist solution is cooled by a treatment solution temperature adjusting apparatus 81, for example, to 33° C. and discharged from the nozzle 32 onto the wafer W. Once heating the resist solution as described above allows an undissolved substance in a gel form contained in the resist solution to dissolve again in the resist solution. Accordingly, defects on the resist pattern on the wafer W caused by the undissolved substance can be reduced. Note that the heat processing apparatus 80 is preferably provided near the nozzle 32.

Though the temperature of the atmosphere in the cup 22 of the resist coating unit 2 is set at 28° C. in the above embodiments, it may be set at 35° C. to 40° C. In this case, the drying time of the resist film in the resist coating treatment can be reduced more. According to the findings of the inventors, the drying time can be reduced by about 50% from that in the prior art. This can further improve the throughput of the treatment of wafers W.

Preferred embodiments of the present invention have been described above with reference to the accompanying drawings, but the present invention is not limited to the embodiments. It should be understood that various changes and modifications are readily apparent to those skilled in the art within the spirit as set forth in claims, and those should also naturally be covered by the technical scope of the present invention. The present invention can take, not limited to the embodiments, various forms. For example, while the present invention has been described taking the coating treatment of the resist solution as an example in the above embodiments, the present invention is also applicable to the coating treatment of a coating solution other than the resist solution, for example a coating solution to form an anti-reflection film, an SOG (Spin On Glass) film, an SOD (Spin On Dielectric) film or the like, or to a developing solution. Though the above embodiments are examples of performing coating treatment on the wafer W, the present invention is also applicable to a coating treatment for a substrate other than the wafer, such as an FPD (Flat Panel Display), a mask reticle for a photomask, and the like.

The present invention is useful for treatment of a substrate such as a semiconductor wafer or the like, for example, when applying a coating solution to the substrate.

What is claimed is:

1. A method of treating a substrate comprising: a temperature adjustment step of adjusting a temperature of the substrate; and a coating treatment step of thereafter holding the substrate by a holding member and applying a coating solution onto the substrate,
wherein in said temperature adjustment step, a temperature of a contact portion of the substrate coming into contact with the holding member is adjusted to be the same as a temperature of the holding member when the substrate is held on the holding member.

2. The method of treating a substrate as set forth in claim 1,
wherein the temperature of the holding member is measured, and the temperature adjustment of the contact portion in said temperature adjustment step is controlled based on the measured temperature of the holding member.

3. The method of treating a substrate as set forth in claim 1,
wherein in said temperature adjustment step, a temperature of a portion of the substrate other than the contact portion is adjusted to be different from the temperature of the contact portion.

4. A computer-readable storage medium storing a program running on a computer of a control unit which controls a substrate treatment apparatus in order to execute a method of treating a substrate by the substrate treatment apparatus,
said method of treating a substrate comprising: a temperature adjustment step of adjusting a temperature of the substrate; and a coating treatment step of thereafter holding the substrate by a holding member and applying a coating solution onto the substrate, wherein in said temperature adjustment step, a temperature of a contact portion of the substrate coming into contact with the holding member is adjusted to be the same as a temperature of the holding member when the substrate is held on the holding member.
